(19) United States
(12) Patent Application Publication
(10) Pub. No.: US 2005/0044717 A1
(43) Pub. Date: Mar. 3, 2005

(54) Folding knife with lock mechanism

(76) Inventor: Tomio Nishihara, Seki-shi (JP)

Correspondence Address: POSZ & BETHARDS, PLC, 11250 ROGER BACON DRIVE, SUITE 10, RESTON, VA, 20190, US

(21) Appl. No.: 10/651,052

(22) Filed: Aug. 29, 2003

(51) Int. Cl. B26B 3/06

(52) U.S. Cl. 30/161

(57) ABSTRACT

A folding knife is provided with a handle and a blade which is pivotally supported by the handle through a blade shaft. The blade has a tang provided with a cam surface. The cam surface contains a substantially arcuate guide portion and an engage portion formed contiguous to one end of the guide portion. A lock plate is rotatably supported by the handle. The lock plate is rotatable between a lock position where it is engaged with the engage portion and an unlock position where it is disengaged from the engage portion. When the blade is located at an open extended position, a torsion spring rotates the lock plate so as to lock the blade against the handle. Thus, the blade is securely locked at the open extended position.

### BACKGROUND OF THE INVENTION

The present invention relates to a folding knife that has a locking mechanism for locking a blade at an open extended position.

A conventional folding knife includes a handle and a blade, which is pivotally supported at the distal end portion of the handle. A shaft is mounted in the distal end portion of the handle and extends perpendicular to the blade. The tang of the blade is pivotally supported by the shaft. The blade is movable between a retracted storage position (resting position) where the blade is retracted into a recess of the handle and an open extended position (working position) where the blade is exposed and extends from the handle.

The folding knife is also provided with a locking mechanism for locking the blade at the open extended position. Various types of locking mechanisms for that purpose have conventionally been proposed and are put into practical uses. A locking mechanism should fulfill various conditions, e.g., it should be capable of locking a blade securely, it should be operated easily for locking and unlocking the blade, and it should have a simple structure. However, there are very few locking mechanisms that can meet these conditions completely.

### SUMMARY OF THE INVENTION

It is an objective of the present invention to provide a folding knife having a novel and improved locking mechanism.

To achieve the foregoing objective, the folding knife according to the present invention is provided with a handle and a blade attached to the handle. The blade is rotatable about a pivot axis provided in the handle. The blade is movable between a retracted storage position where the blade is stored in the handle and an open extended position where the blade is exposed and extends from the handle. The blade has a tang which is positioned within the handle when the blade is located at the open extended position. A cam surface is formed on the peripheral edge of the tang. The cam surface contains a substantially arcuate guide portion extending arcuately around the pivot axis and an engage portion formed contiguous to one end of the guide portion. A lock plate is supported by the handle to be rotatable about an axis parallel to the pivot axis. The lock plate is rotatable between a lock position and an unlock position; at the lock position, the lock plate engages with the engage portion so as to lock the blade at the open extended position, whereas at the unlock position the lock plate disengages from the engage portion so as to permit the blade to move from the open extended position. When the blade is located at the open extended position, the lock plate is permitted to rotate between the lock position and the unlock position, whereas when the blade is located at the unlock position, the blade is permitted to move between the open extended position and the retracted storage position with the guide portion opposing the lock plate. The folding knife is also provided with an urging member for urging the lock plate from the unlock position toward the lock position. When the blade is located at the open extended position, the urging member rotates the lock plate toward the lock position so as to lock the blade against the handle.

### BRIEF DESCRIPTION OF THE DRAWINGS

The features of the present invention that are believed to be novel will become apparent particularly from the appended claims. The invention together with the objects and advantages thereof may best be understood by reference to the following description of the presently preferred embodiments together with the accompanying drawings.

FIG. 1 is a front view of a folding knife according to one embodiment of the present invention, with a blade thereof being located at the open extended position;

FIG. 2 is a plan view of the knife shown in FIG. 1;

FIG. 3 is a back view of the knife shown in FIG. 1;

FIG. 4 is a front view of the knife shown in FIG. 1, with the blade being located at the retracted storage position;

FIG. 5 is a cross-sectional front view of the knife shown in FIG. 1, with a first side wall being removed;

FIG. 6 is a cross-sectional front view of the knife shown in FIG. 4, with the first side wall being removed; and

FIGS. 7-10 are enlarged-cross-sectional views of the relevant portion for explaining sequentially the movement of the locking mechanism.

### DETAILED DESCRIPTION OF THE PREFERRED EMBODIMENTS

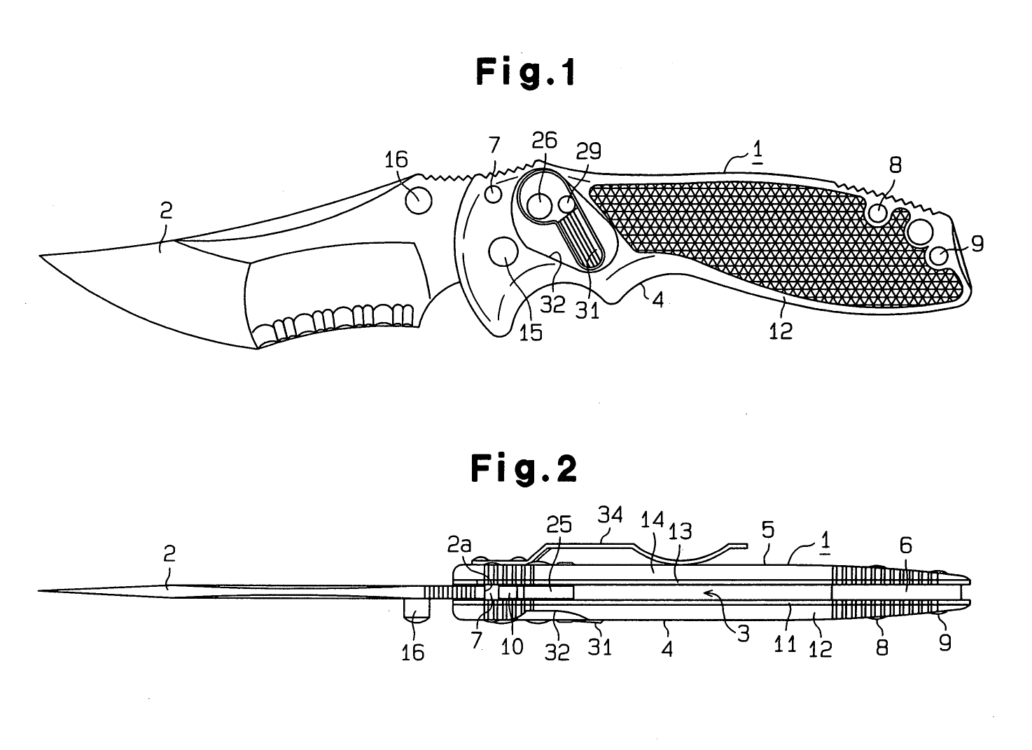

One embodiment of the present invention will be described with reference to FIGS. 1-10. As shown in FIGS. 1-6, the folding knife includes a handle 1 and a blade 2, which is pivotally attached to the distal end portion of the handle 1. The blade 2 is movable between a retracted storage position (see FIGS. 4-6) where the blade 2 is stored in a storage 3 of the handle 1 and an open extended position (see FIGS. 1-3, 5) where the blade 2 is exposed and extends from the handle 1. The retracted storage position corresponds to a resting position for the blade 2, and the open extended position corresponds to a working position for the blade 2.

The handle 1 has a first side wall 4, a second side wall 5 and a metallic spacer 6 interposed between them in the vicinity of the proximal end portion of the handle 1. The side walls 4, 5 are connected to each other with the spacer 6 interposed between them by a first connecting pin 7, a second connecting pin 8 and a third connecting pin 9. The side walls 4, 5 and the spacer 6 define the storage 3. The first side wall 4 contains a liner 11 and an outer plate 12, which is located outside the liner 12. The second side wall 5 likewise contains a liner 13 and an outer plate 14, which is located outside the liner 13. The liners 11, 13 are preferably made of a metallic material. While the outer plates 12, 14 are preferably made of a synthetic resin material or wood, they may be made of a metallic material.

The first connecting pin 7 penetrates the side walls 4, 5 in the vicinity of the upper edge at the distal end portion of the handle 1. The second and third connecting pins 8, 9 penetrate the side walls 4, 5 and the spacer 6 in the vicinity of the proximal end portion of the handle 1.

A blade shaft 15 penetrates the side walls 4, 5 at the distal end portion of the handle 1. The blade 2 has at the proximal end portion a tang 10 that is pivotally supported by the blade shaft 15. The axis of the blade shaft 15, which is a pivot axis of the blade 2, extends perpendicular to the blade 2. The tang 10 is always located within the handle 1 and is held between the liners 11, 13. A knob 16 extends from one side of the blade 2 in the vicinity of the tang 10. A user can rotate the blade 2 from the retracted storage position to the open extended position by operating the knob 16 with a thumb or a finger or holding the portion of the blade 2 exposing from the handle 1 with fingers and pulling it. The knob 16 may be designed to extend from both sides of the blade 2.

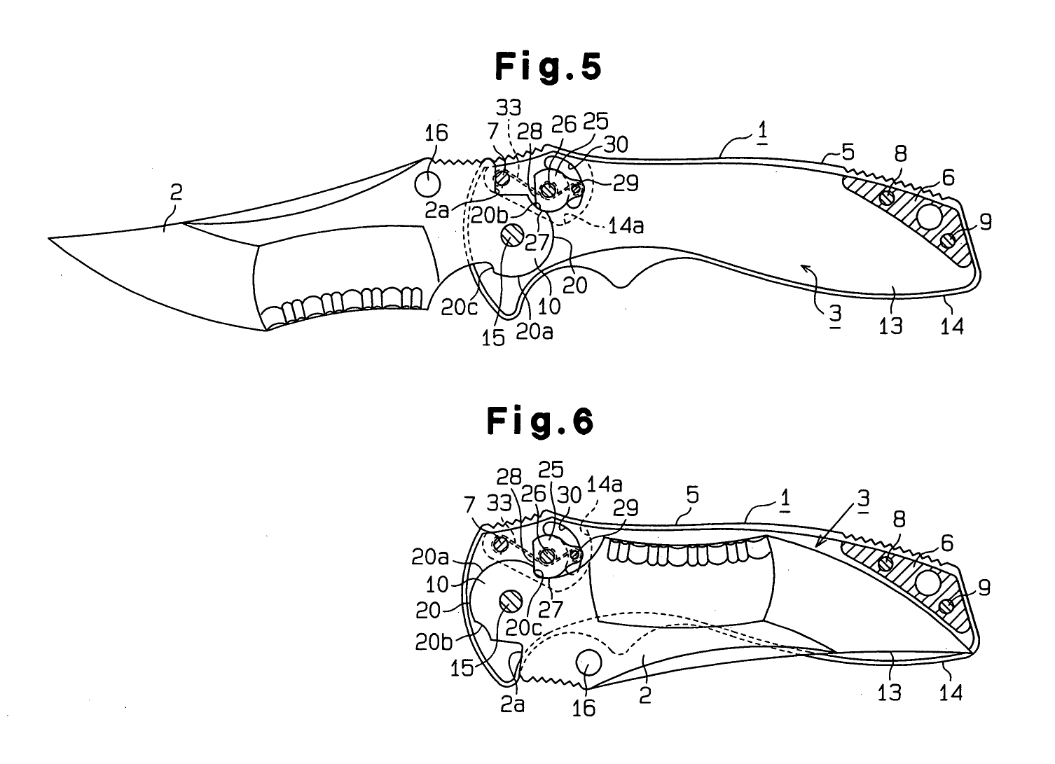

The first connecting pin 7 functions as a stopper. As shown in FIGS. 5, 6, the blade 2 has an abutting portion 2a, which can be abutted against the first connecting pin 7, in the vicinity of the proximal end portion, more specifically at the boundary between the blade portion and the tang 10 of the blade 2. As shown in FIG. 5, when the blade is rotated to the open extended position, the abutting portion 2a is engaged with the first connecting pin 7 to prevent the blade 2 from rotating beyond the open extended position.

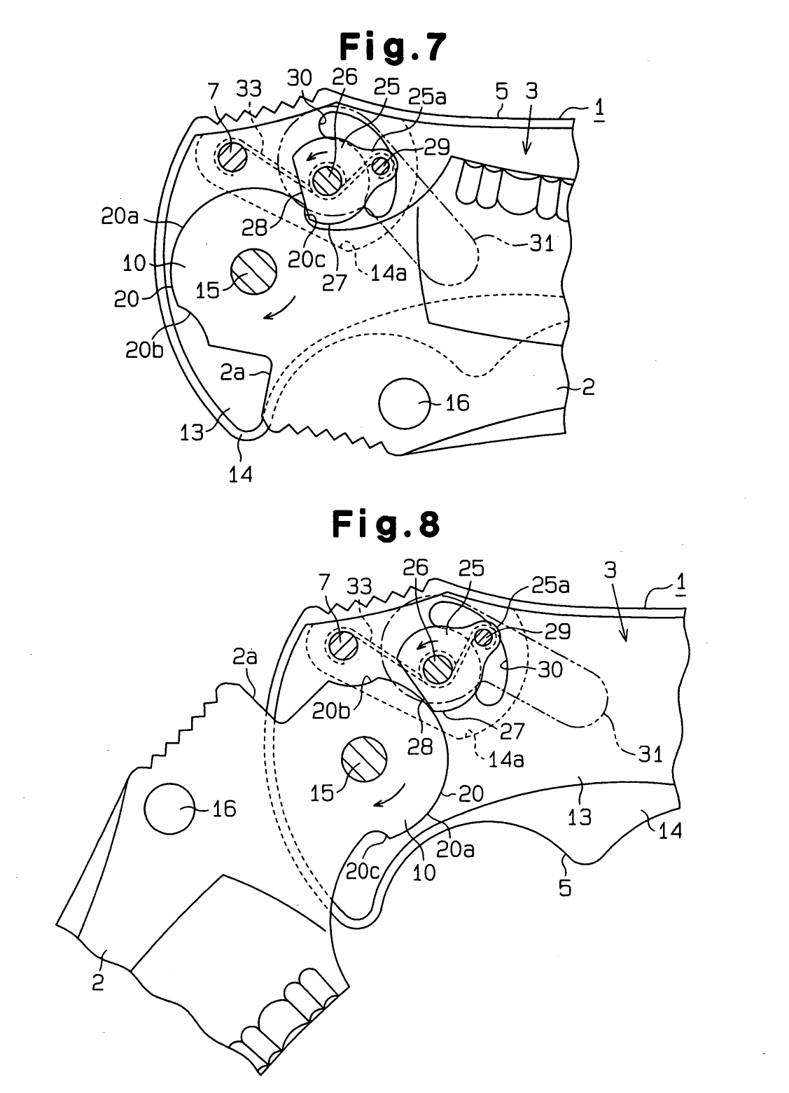

As shown in FIGS. 7-10, the peripheral edge of the tang 10 forms a cam surface 20. The cam surface 20 contains an arcuate guide portion 20a that extends arcuately around the axis of the blade shaft 15 and a first engage portion 20b formed contiguous to one end of the guide portion 20a. The first engage portion 20b has an inverted arcuate shape and curves inward from that end of the guide portion 20a along the radius of the blade shaft 15. The cam surface 20 also contains a second engage portion 20c formed contiguous to the other end of the guide portion 20a. The second engage portion 20c extends from the other end of the guide portion 20a curving inward along the radius of the blade shaft 15. A jaw-like angular portion is formed between the guide portion 20a and the second engage portion 20c.

The handle 1 supports a substantially disc-shaped lock plate 25 such that it can rotate about an axis parallel to that of the blade shaft 15. The lock plate 25 has a thickness substantially equal to that of the tang 10 and is arranged between the side walls 4, 5 on a plane that intersects orthogonally to the axis of the blade shaft 15 and contains the tang 10. The lock plate 25 is supported by a lock plate shaft 26 that is parallel to the axis of the blade shaft 15 and penetrates the side walls 4, 5.

The peripheral edge of the lock plate 25 opposes the cam surface 20 of the tang 10. The peripheral edge of the lock plate 25 contains an arcuate lock surface 27 and a flat release surface 28 formed contiguous to the lock surface 27. The first engage portion 20b has a profile that substantially matches the arcuate profile of the lock surface 27. The center of the arc containing the lock surface 27 is deviated from the pivot axis of the lock plate 25 or the axis of the lock plate shaft 26. More specifically, the center of the arc containing the lock surface 27 is present far from the release surface 28 compared with the pivot axis of the lock plate 25.

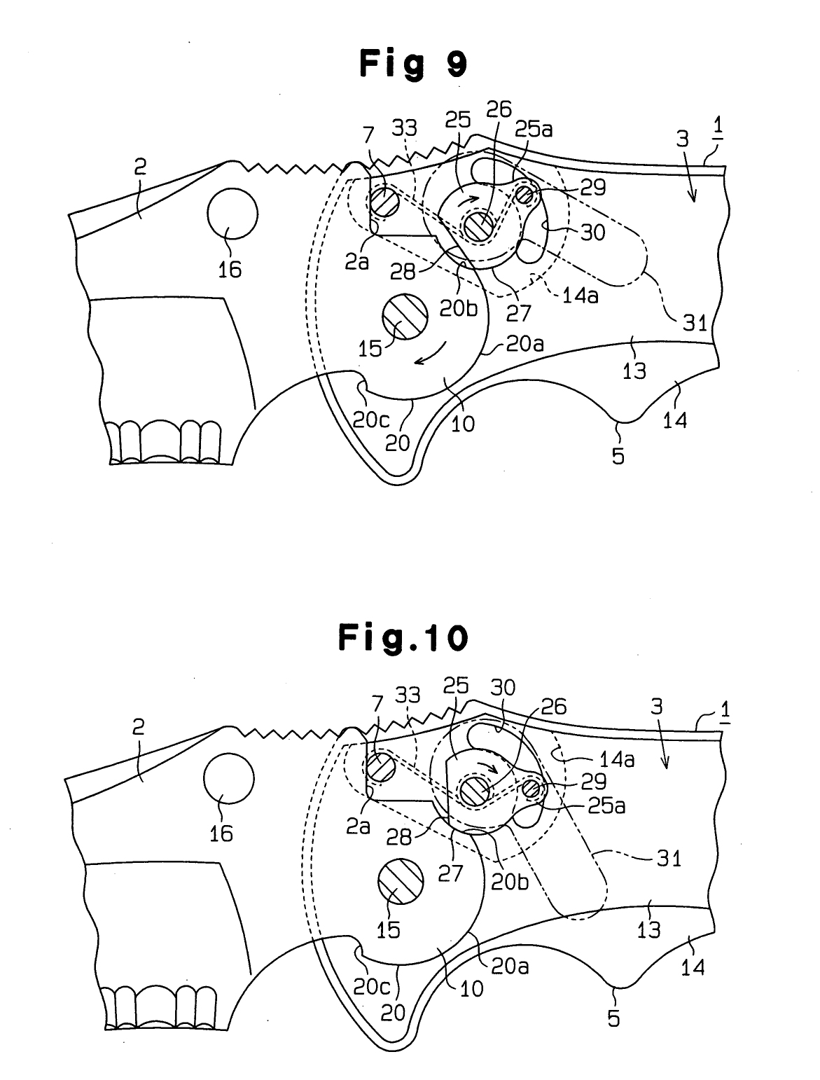

In the state where the blade 2 is located at the open extended position, the lock plate 25 can rotate between a lock position shown in FIG. 10 and an unlock position shown in FIG. 9. At the lock position shown in FIG. 10, the lock surface 27 of the lock plate 25 engages with the first engage portion 20b, so that the blade 2 is locked at the open extended position. At the unlock position shown in FIG. 9, the lock surface 27 of the lock plate 25 is disengaged from the first engage portion 20b to let the release surface 28 of the lock plate 25 oppose the first engage portion 20b. Thus, the blade 2 is permitted to rotate from the open extended position toward the retracted storage position.

As shown in FIGS. 7-10, the lock plate 25 has a protruded portion 25a protruding radially outward from the opposite side across from the release surface 28. A guide pin 29 is fixed to the protruded portion 25a. The guide pin 29 extends parallel to the pivot axis of the lock plate 25 or the axis of the lock plate shaft 26 and protrudes from each side of the protruded portion 25a. The side walls 4, 5 each contain a guide slot 30, which receives one end portion of the guide pin 29. It should be noted here that only the guide slot 30 formed in the second side wall 5 is shown in the drawings. The guide slot 30 extends arcuately along the travel route of the guide pin 29. When the lock plate 25 rotates, the guide pin 29 moves along the guide slot 30.

As shown in FIGS. 1-4, a lever 31 serving as a manual operation member is provided on one side of the handle 1, more specifically on the outer side of the first side wall. The lever 31 is connected to one end portion of the lock plate shaft 26 and to one end portion of the guide pin 29. More specifically, the lever 31 is connected to the lock plate 25 through the lock plate shaft 26 and the guide pin 29 so that the lever 31 can rotate integrally with the lock plate 25. The lock plate 25 can be rotated if a user operates the lever 31 with a thumb or a finger.

The first side wall 4, more specifically the outer plate 12, has a depression 32, in which the lever 31 is placed, formed on the outer surface around the portion corresponding to the location of the lever 31. As shown in FIG. 2, the lever 31 is designed not to protrude substantially from the outer surface of the first side wall 4 due to the presence of the depression 32.

As shown in FIGS. 7-10, the second side wall 5 contains a torsion spring 33 as an urging member for urging the lock plate 25 from the unlock position toward the lock position. This torsion spring 33 is disposed about the lock plate shaft 26 and has one end portion which is retained by the first connecting pin 7 and the other end portion which is retained by the guide pin 29. In other words, the torsion spring 33 has one end portion connected to the handle 1 through the first connecting pin 7 and the other end portion connected to the lock plate 25 through the guide pin 29 at a position deviated from the pivot axis of the lock plate 25.

The torsion spring 33 is disposed between the liner plate 13 and the outer plate 14, which constitute the second side wall 5. In this embodiment, the outer plate 14 has a depression 14a formed on the inner surface opposing the liner plate 13 so as to place the torsion spring 33 therein. The depression defining the space for placing the torsion spring 33 may be formed on the outer surface of the liner 13 opposing the outer plate 14. Otherwise, the liner 13 may be notched at the portion corresponding to the location of the torsion spring 33, and the torsion spring 33 may be placed in the space defined by notching. Further, it is possible to dispose one torsion spring 33 on each side of the lock plate 25.

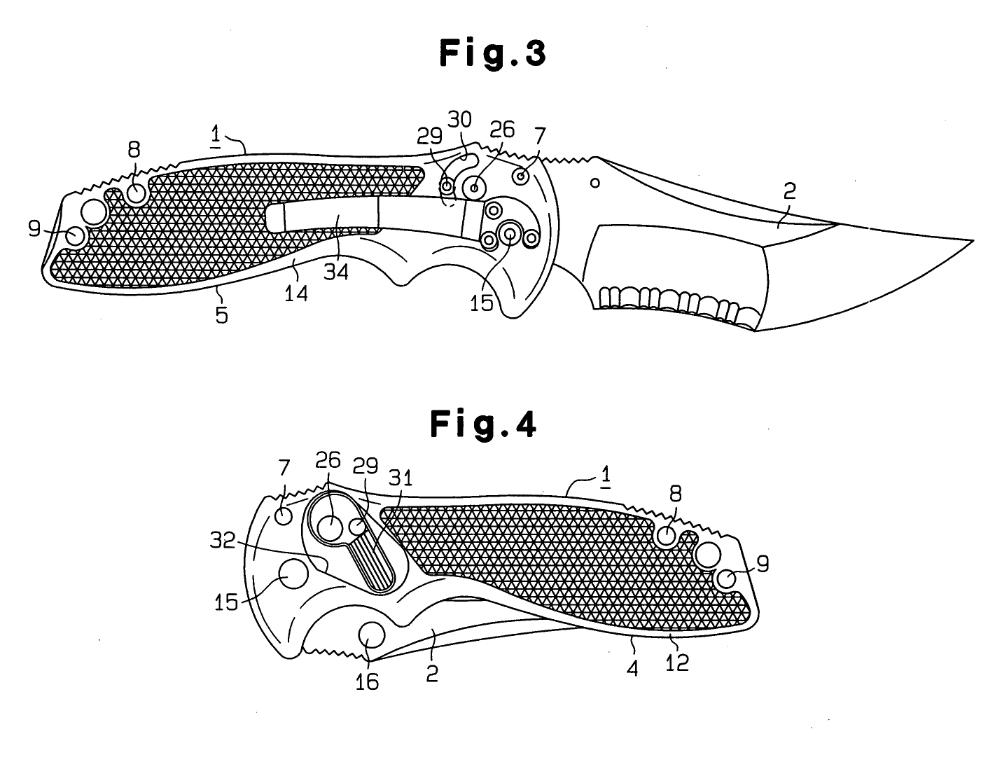

As shown in FIGS. 2, 3, a clip 34 is secured to the outer surface of the second side wall 5. By use of the clip 34, a user can clip the knife onto his or her pocket, belt, etc.

FIG. 6 shows a state where the blade 2 is located at the retracted storage position. In this state, the blade 2 is abutted at around the proximal end portion thereof against the peripheral edge of the lock plate 25 to prevent the blade 2 from rotating beyond the retracted storage position. Further, the lock plate 25 is located at the lock position, and the release surface 28 of the lock plate 25 is engaged with the second engage portion 20c of the tang 10. The torsion spring 33 urges the lock plate 25 clockwise in FIG. 6 from the unlock position toward the lock position. Thus, the lock plate 25 presses the second engage portion 20c to impart the blade 2 a counterclockwise turning force in FIG. 6. Therefore, the blade 2 is held securely at the retracted storage position shown in FIG. 6 and is prevented from unexpectedly popping out of the storage 3.

If the blade 2 is rotated from the retracted storage position shown in FIG. 6 toward the open extended position, the angled portion present between the guide portion 20a and the second engage portion 20c of the tang 10 presses the release surface 28 as shown in FIG. 7. Thus, the lock plate 25 is rotated counterclockwise in FIG. 7 toward the unlock position against the resistance of the urging force of the torsion spring 33.

With the rotating movements of the blade 2 and the lock plate 25, the second engage portion 20c of the tang 10 disengages from the release surface 28 of the lock plate 25 to let the guide portion 20a of the tang 10 oppose the release surface 28, as shown in FIG. 8. In the state shown in FIG. 8, the lock plate 25 is rotated to the unlock position. The lock plate 25 is urged by the torsion spring 33 such that the release surface 28 is pressed against the guide portion 20a. Thus, the blade 2 is rotated toward the open extended position as the guide portion 20a slides along the release surface 28 with the lock plate 25 being held at the unlock position. Since the release surface 28 is pressed against the guide portion 20a with an appropriate force, the blade 2 can be rotated stably.

When the blade 2 is rotated to the open extended position, the abutting portion 2a of the blade 2 is abutted against the first connecting pin 7, as shown in FIG. 9, to prevent the blade 2 from rotating beyond the open extended position. Further, the guide portion 20a disengages from the release surface 28 to let the first engage portion 20b of the tang 10 oppose the release surface 28. Thus, the lock plate 25 is rotated by the urging force of the torsion spring 33 from the unlock position shown in FIG. 9 to the lock position shown in FIG. 10. In other words, the lock plate 25 enters the range of the rotation route of the tang 10. At the lock position shown in FIG. 10, the lock surface 27 of the lock plate 25 engages with the first engage portion 20b of the tang 10. Thus, the blade 2 located at the open extended position is locked against the handle 1.

The center of the arc containing the lock surface 27 is present far from the release surface 28 compared with the pivot axis of the lock plate 25. Therefore, when the lock plate 25 rotates from the unlock position shown in FIG. 9 to the lock position shown in FIG. 10, the lock surface 27 approaches the first engage portion 20b gradually to engage with it. More specifically, in the state where the lock plate 25 is located between the unlock position shown in FIG. 9 and the lock position shown in FIG. 10, a very small clearance is present between the lock surface 27 and the first engage portion 20b. The clearance reduces gradually as the lock plate 25 approaches the lock position shown in FIG. 10. The clearance disappears when the lock plate 25 reaches the lock position shown in FIG. 10, and the lock surface 27 engages with the first engage portion 20b. Therefore, the lock plate 25 rotates smoothly from the unlock position to the lock position.

Meanwhile, when the blade 2 in the state shown in FIG. 10 is subject to a force directed toward the retracted storage position (counterclockwise force in FIG. 10), a rotation force (clockwise force in FIG. 10) acts upon the lock plate 25 from the unlock position toward the lock position. Thus, the lock surface 27 is pressed firmly against the first engage portion 20b of the tang 10 to ensure holding of the blade 2 in the locked state.

When a user operates the lever 31 with a thumb or a finger to rotate the lock plate 25 toward the unlock position against the resistance of the force of the torsion spring 33, the blade 2 is unlocked. More specifically, if the lock plate 25 is rotated from the lock position shown in FIG. 10 to the unlock position shown in FIG. 9 by manually operating the lever 31, the lock surface 27 is disengaged from the first engage portion 20b to let the release surface 28 oppose the first engage portion 20b. The release surface 28 is located on the travel route of the guide portion 20a or at a position deviated from the route. Thus, the blade 2 is permitted to rotate from the open extended position toward the retracted storage position. Therefore, the blade 2 is brought to the retracted storage position shown in FIG. 6 going through the states shown in FIGS. 8 and 7 by rotating the blade 2 counterclockwise in FIG. 9 with the lock plate 25 being located at the unlock position.

The embodiment of the present invention detailed above enjoys the following advantages.

When the blade 2 is located at the open extended position, the arcuate lock surface 27 of the lock plate 25 is engaged with the first engage portion 20b of the cam surface 20 formed in the tang 10. The lock plate 25 is pressed against the first engage portion 20b by the force of the torsion spring 33. Further, the lock surface 27 is brought into face contact with the first engage portion 20b over a relatively large surface area. Thus, the blade 2 is locked securely and stably and is securely prevented from swinging in its rotation direction with respect to the handle 1.

Even if a great force directed toward the retracted storage position acts upon the blade 2 in the locked state, the lock plate 25 engaged with the first engage portion 20b does not disengage from the first engage portion 20b. The locked state of the blade 2 cannot be released unless a user operates the lever 31.

The force acting upon the locked blade 2 toward the retracted storage position is received by the lock plate shaft 26 through the first engage portion 20b and the lock plate. While the lock plate shaft 26 is rotatable together with the lock plate 25 with respect to the handle 1, the lock plate shaft 26 is supported by the handle 1 so as not to be able to change its position. Therefore, the force acting upon the locked blade 2 can be received securely by the lock plate shaft 26 supported stably by the handle 1.

The lever 31 is placed in the depression 32 formed on the outer surface of the first side wall 4 such that it may not protrude substantially from the outer surface of the first side wall 4. Thus, there is almost no danger that the lever 31 will be moved inadvertently, and it is very unlikely that the locked state of the blade 2 will be released inadvertently.

The lever 31 extends radially outward with respect to the pivot axis of the lock plate 25. Thus, a user can rotate the lock plate 25 from the lock position to the unlock position merely by operating the lever 31 with a relatively small force.

The mechanism for locking the blade 2 is simple and is composed of a relatively small number of parts including the lock plate 25, the torsion spring 33 and the lever 31. In addition, operation of the mechanism is relatively simple. Therefore, production cost can be reduced, and it is unlikely that problems will occur in the locking function.

The embodiment of the present invention may be modified as follows.

The shape of the lock plate 25 is not limited to the one illustrated in the drawings but may be modified suitably. For example, the portion of the lock plate 25 other than the lock surface 27 and release surface 28 may be changed to other shapes. Further, the lock plate 25 may not have the flat release surface 28 but may be an elliptic plate or may be a circular plate having a peripheral surface which is eccentric with respect to its pivot axis.

The depression 32 for placing the lever 31 therein may be omitted.

Although only some embodiments of the present invention are described, it should be apparent to those skilled in the art that the present invention may be embodied in many other specific forms without departing from the spirit or scope of the invention. The invention is not to be limited to the details given herein, but may be modified within the scope of the appended claims.

1. A folding knife comprising:
a handle;
a blade attached to the handle, wherein the blade is rotatable about a pivot axis provided in the handle, wherein the blade is movable between a retracted storage position where the blade is stored in the handle and an open extended position where the blade is exposed and extends from the handle, and wherein the blade has a tang which is positioned within the handle when the blade is located at the open extended position;
a cam surface formed on the peripheral edge of the tang, wherein the cam surface contains a substantially arcuate guide portion extending arcuately around the pivot axis and an engage portion formed contiguous to one end of the guide portion;
a lock plate supported by the handle to be rotatable about an axis parallel to the pivot axis, wherein the lock plate is rotatable between a lock position where the lock plate engages with the engage portion so as to lock the blade at the open extended position, and an unlock position where the lock plate disengages from the engage portion so as to permit the blade to move from the open extended position, and wherein when the blade is located at the open extended position, the lock plate is permitted to rotate between the lock position and the unlock position, whereas when the lock plate is located at the unlock position, the blade is permitted to move between the open extended position and the retracted storage position with the guide portion opposing the lock plate; and
an urging member for urging the lock plate from the unlock position toward the lock position, wherein when the blade is located at the open extended position, the urging member rotates the lock plate toward the lock position so as to lock the blade against the handle.

2. The folding knife according to claim 1, further comprising a manual operation member for rotating the lock plate from the lock position toward the unlock position.

3. The folding knife according to claim 2, wherein the manual operation member is a lever provided on one side of the handle, and the lever is connected to the lock plate to be rotatable integrally with the lock plate.

4. The folding knife according to claim 3, wherein the handle has on one side thereof a depression for placing the lever therein.

5. The folding knife according to claim 1, wherein the lock plate has a substantially disc shape and also has a peripheral edge which opposes the cam surface of the tang, wherein the peripheral edge of the lock plate has an arcuate lock surface which is engageable with the engage portion, wherein the engage portion has an inverted arcuate shape that substantially matches the arcuate profile of the lock surface, and wherein the lock surface engages with the engage portion when the lock plate is rotated to the lock position with the blade being located at the open extended position.

6. The folding knife according to claim 5, wherein the arc containing the lock surface has a center deviated from an axis of the lock plate.

7. The folding knife according to claim 5, wherein the peripheral edge of the lock plate contains a flat release surface formed contiguous to the lock surface, and wherein when the lock plate is rotated to the unlock position with the blade being located at the open extended position, the lock surface disengages from the engage portion to let the release surface oppose the engage portion.

8. The folding knife according to claim 7, wherein the lock plate is held at the unlock position when the release surface is abutted against the guide portion, and wherein the blade moves between the open extended position and the retracted storage position as the guide portion slides along the release surface.

9. The folding knife according to claim 1, wherein the lock plate and the engage portion are formed such that a rotating force directed from the unlock position toward the lock position acts upon the lock plate when the blade is subject to a force directed from the open extended position toward the retracted storage position with the lock plate being engaged with the engage portion.

10. The folding knife according to claim 1, wherein the engage portion is a first engage portion formed contiguous to one end of the guide portion, wherein the cam surface further contains a second engage portion formed on the other end of the guide portion, and wherein when the blade is located at the retracted storage position, the urging member urges the lock plate so as to engage the lock plate with the second engage portion and thus holds the blade at the retracted storage position.

11. The folding knife according to claim 1, wherein the handle has a stopper which engages with the blade located at the open extended position to prevent the blade from rotating over the open extended position.

12. The folding knife according to claim 1, wherein the lock plate has a guide pin extending parallel to the axis of the lock plate, and wherein the handle has a guide slot which receives the guide pin and extends along a travel route of the guide pin.

13. The folding knife according to claim 1, wherein the urging member is a torsion spring disposed around the axis of the lock plate, and wherein the torsion spring has one end portion which is connected to the handle and the other end portion which is connected to the lock plate at a position deviated from the axis of the lock plate.

14. A folding knife comprising:
a handle having a pair of side walls, wherein the handle has a distal end portion and a proximal end portion;
a blade shaft attached to the distal end portion of the handle, wherein the blade shaft has an axis traversing the handle;
a blade disposed between the side walls and supported by the blade shaft to be rotatable with respect to the handle, wherein the blade can move between a retracted storage position where the blade is stored within the handle and an open extended position where the handle is exposed and extends from the handle, and wherein the blade has a tang to be positioned within the handle when the blade is located at the open extended position;
a cam surface formed on the peripheral edge of the tang, wherein the cam surface contains a substantially arcuate guide portion extending arcuately around the axis of the blade shaft and an engage portion formed contiguous to one end of the guide portion;
a substantially disc-shaped lock plate supported by the handle to be rotatable about an axis parallel to the axis of the blade shaft, wherein the lock plate is interposed between the side walls, and has a peripheral edge which opposes the cam surface of the tang, wherein the peripheral edge of the lock plate contains an arcuate lock surface which is engageable with the engage portion and a flat release surface formed contiguous to the lock surface, wherein the lock plate is rotatable between a lock position where the lock surface engages with the engage portion so as to lock the blade at the open extended position, and an unlock position where the lock surface disengages from the engage portion so as to permit the blade to move from the open extended position, and wherein when the blade is located at the open extended position, the lock plate is permitted to rotate between the lock position and the unlock position, whereas when the lock plate is located at the unlock position, the blade is permitted to move between the open extended position and the retracted storage position with the guide portion opposing the release surface;
a spring for urging the lock plate from the unlock position toward the lock position, wherein when the blade is located at the open extended position, the spring rotates the lock plate toward the lock position so as to lock the blade against the handle; and
a manual operation member for rotating the lock plate from the lock position toward the unlock position.

15. The folding knife according to claim 14, wherein the manual operation member is a lever provided on one side of the handle, and wherein the lever is connected to the lock plate to be rotatable integrally therewith.

16. The folding knife according to claim 14, wherein the lock plate has a guide pin extending parallel to an axis of the lock plate, and wherein the handle has a guide slot which receives the guide pin and extends along a travel route of the guide pin.

17. A folding knife comprising:
a handle;
a blade attached to the handle, wherein the blade is rotatable about a pivot axis provided in the handle, wherein the blade is movable between a retracted storage position where the blade is stored in the handle and an open extended position where the blade is exposed and extends from the handle, and wherein the blade has a tang which is positioned within the handle when the blade is located at the open extended position;
a stopper provided in the handle, wherein the stopper engages with the blade located at the open extended position to prevent the blade from rotating beyond the open extended position;
a cam surface formed on the peripheral edge of the tang, wherein the cam surface contains a substantially arcuate guide portion extending arcuately around the pivot axis and an engage portion formed contiguous to one end of the guide portion;
a lock plate supported by the handle to be rotatable about an axis parallel to the pivot axis, wherein the lock plate is rotatable between a lock position where the lock plate engages with the engage portion so as to lock the blade at the open extended position, and an unlock position where the lock plate disengages from the engage portion so as to permit the blade to move from the open extended position;
an urging member for urging the lock plate from the unlock position toward the lock position, wherein when the blade is located at the open extended position, the urging member rotates the lock plate toward the lock position so as to lock the blade against the handle; and
a lever for rotating the lock plate from the lock position toward the unlock position, wherein the lever is connected to the lock plate to be rotatable integrally therewith and is disposed on one side of the handle so that it is operated manually.
